(19) United States
(12) Patent Application Publication
(10) Pub. No.: US 2025/0336394 A1
(43) Pub. Date: Oct. 30, 2025

(54) ANONYMOUS REAL-TIME CUSTOMER FEEDBACK SYSTEM

(71) Applicant: Ross Blankenship, Edwards, CO (US)

(72) Inventor: Ross Blankenship, Edwards, CO (US)

(21) Appl. No.: 18/649,573

(22) Filed: Apr. 29, 2024

(51) Int. Cl. G10L 15/183; G06F 21/62; G10L 15/08; H04R 1/40; H04R 3/00

(52) U.S. Cl. CPC G10L 15/183; G06F 21/6254; H04R 1/406; H04R 3/005; G10L 2015/088

(57) ABSTRACT

The invention is a system and method for anonymously capturing customer feedback in real time. Multiplexed voice inputs are converted to digital signal equivalents, translated, interpreted, and categorized. The commentary is judged as to positive or negative perception, and reported as anonymous feedback.

### TECHNICAL FIELD

The invention is a system for anonymously capturing real-time customer feedback.

### BACKGROUND OF INVENTION

One of the advantages of online ordering and delivery is the potential for capturing customer feedback on products and services.

For example, like many others, the United States Patent and Trademark Office will, when people call to query about various patent- and trademark-related procedures, invite the caller to remain on the line, afterward, for a brief survey.

Some businesses will follow up a purchase or customer-support event with an email requesting a customer fill out a brief survey.

It is good to solicit inputs from customers, and to do so as soon after an engagement as possible. But, many potential feedback providers will balk because, if done hours or days later, they may not remember specific details and just have a general impression. Others may balk because if they have been emailed, they do not wish to be identified, especially if the feedback would be highly negative.

A system and method that gathered feedback in real-time, and did so while keeping sources anonymous, could offer more useful results and perhaps enable an immediate remedy rather than after-the-fact apologies.

### BRIEF DESCRIPTION OF INVENTION

The invention herein disclosed and claimed is a system and method for capturing real-time feedback from customers while preserving their anonymity. Multiple microphones inconspicuously placed can capture customer conversations. Using multiplexing, microphone inputs are sampled sequentially for predetermined sampling times.

Using natural-language models and machine-learning subsystems, conversational excerpts are filtered for key words. If none are identified during a sampling time, the next microphone is sampled, and so on.

If a key word or words is identified, the multiplexing is halted and that microphone stays connected to the natural-language model and machine-language subsystems. The conversation is translated and interpreted. Based on captured phrases and comments, one or more categories of feedback, such as service-related, are processed and evaluated. Within a short amount of time, a file can be compiled wherein relative metrics are assigned to various categories based on feedback.

In a restaurant situation, for example, microphones could be sampling feedback of patrons who are awaiting a table, or seated patrons awaiting a first waitperson encounter, and the like. A manager can quickly glimpse whether there are negative comments about wait times, service response, and so on. Since it is occurring in real time, a manager could take steps to change the dynamic in near-real time. Similar capture of conversational feedback at an airport ticket counter, or a retail store, or a supermarket, or public places, could allow rapid response to an increasingly negative situation.

### BRIEF DESCRIPTION OF DRAWINGS

FIG. 1 shows an example of sensitive microphones inconspicuously mounted on a ceiling.

FIG. 2 illustrates an embodiment of the invention wherein multiple microphones are sampled, sequentially, by multiplexing, and conversation is captured, translated and interpreted.

FIG. 3 illustrates one method embodiment showing the process steps from voice capture to key-word identification, to multiplexor control, and processing of key-word-related feedback.

### DETAILED DESCRIPTION OF INVENTION

There's a benefit to getting feedback about an interaction as soon as possible. When feedback is delayed, details may be forgotten, and impressions may be altered. Ideally, getting feedback in real time could enable taking steps to alleviate a situation prompting negative impressions.

Asking for someone to complete a survey sometime after an interaction runs the risk of that person opting not to do so, or doing so but forgetting what could have been important details and impressions.

In a restaurant scenario, where people are waiting to be seated, one often overhears conversations about how long it is taking, or they must have forgotten about us, or the like. Once seated, conversations such as how long it is taking for someone to take an order, or how long it is taking for an order to be served, would certainly reflect on impressions of service and dissatisfaction.

Sometimes when people are dissatisfied, they will speak out to someone who works at an establishment. Other times, they will quietly seethe with displeasure. The rule of thumb in business, in general, is that when someone has a positive experience they will tell three people. But, when they have a negative experience, they will tell ten people. So, one key business objective could be to reduce the likelihood of negative experiences and increase the likelihood of positive ones.

Eavesdropping on customer comments that relate to their experiences could be a very helpful means for improving customer satisfaction. But, human nature being what it is, people often go quiet when someone they do not know may be within earshot.

The system and method herein specified is a way to capture real-time customer feedback without compromising privacy. And, because it is done while an experience is unfolding, it tends to be unvarnished by delayed responses.

The system is intended for use virtually anywhere customers have entered a business establishment. Comments from different customers are sampled by a multiplexed set of inconspicuously placed microphones. The microphones are sampled sequentially, either in a predetermined sequence, or in a randomly selected sequence. As each microphone is selected to sample commentary, the analog microphone input is converted to digital, and fed into a natural-language model and machine-learning subsystem for translation, interpretation, and key-word filtering. Using contemporary technology, this can be done in fractions of a second.

A microphone's input is sampled for a predetermined default time duration. If no key words are identified, once the sample time has elapsed, the multiplexor switches to another microphone and the process is repeated.

When the natural-language model and machine-learning subsystem identify a key word, the system pauses its multiplexing and focuses on the conversational thread being captured. Using custom-engineered natural-language model and machine-learning processing, tailored to a variety of business categories, the system is able to categorize a captured conversational thread and determine whether the thread describes a positive or negative perception.

As the threads captured from different microphones, spoken by different customers, are processed and reported, a business manager could react to a negative perception by taking immediate action. For example, if several threads relate to excessive wait time before being seated, a manager could go into the waiting area and apologize for the delay in seating and explain that some of the waitpersons are now helping the bus-persons clear tables in order to reduce the wait times. That simple action could reduce or nullify the degree of negative impressions.

A restaurant is just one example of how the system may be embodied and applied. Some of its key elements are the anonymity afforded by unidentified microphone source and only transcribed translation and interpretation with no retention of actual voice inputs.

As with all artificial intelligence-based systems and applications, the artificial-intelligence (AI) subsystems are continuously updated with new labeled data, human-agent oversight, and adjustments to model parameters as new results are folded in. In different business establishments, different key words may be chosen to filter interpreted conversational threads. With regard to labeling and categories in the machine-learning portion, these may be different for different business establishments and categories. Consequently, a more general-purpose approach to translation and interpretation may not be as effective as that made by custom-engineered subsystems.

Model corrections can be helped by human agents overseeing translation, interpretation and characterization and flagging results that are suspect. For example, a conversation might be where someone describes the food as “insane.” The system may have interpreted “insane” as a negative whereas a human agent might see it as a positive.

The following description is meant to make the invention and method more explicit. The description and drawings are exemplary and should not be read as limiting the patent scope.

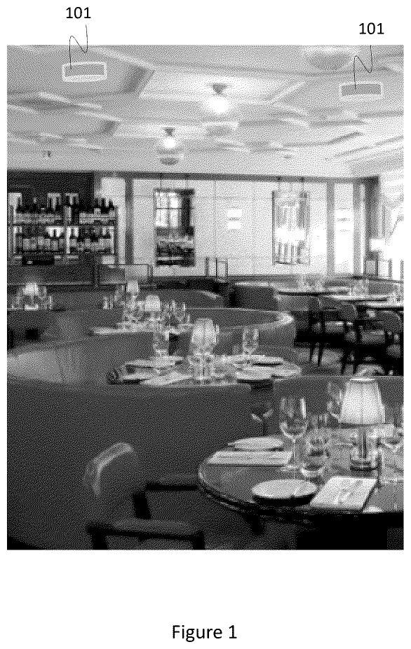

FIG. 1 depicts a restaurant with two microphones (101) installed in the ceiling. Microphone placement is dependent upon the ceiling height, table locations, and sound field.

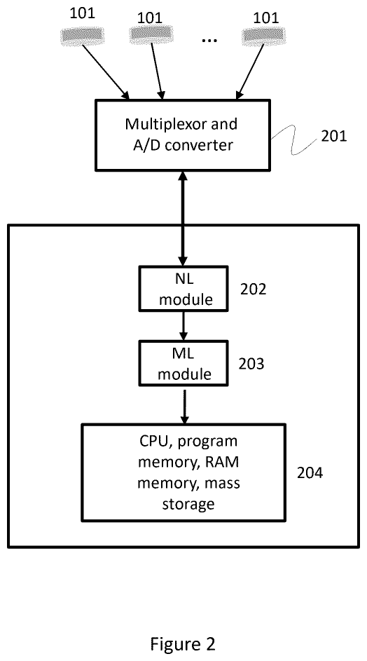

In FIG. 2, the plurality of microphones (101) are input to a subsystem (201) comprising a multiplexor and analog-to-digital (A/D) converter. The multiplexor is sized to input all the microphones and to output one at a time to the A/D which is operative to convert the analog voice signal to its equivalent digital signal. The currently switched microphone's digitized output is conveyed to a natural-language (NL) model module (202) which is operative to translate the digitized voice input into an equivalent text output. The NL subsystem is also operative to interpret slang or idiosyncratic words into proper context. The NL output is conveyed to a machine-learning (ML) module where based on its labeled-data training, it categorizes the captured, translated and interpreted thread to categorize the perception within the scope of predefined categories and to accurately ascribe a negative or positive qualification to it. The ML output is conveyed to a more conventional processing subsystem comprising CPU, program memory, read/write memory, and mass storage. Here the NL/ML processed threads are aggregated and displayed to provide a user with a real-time snapshot of current-thread feedback against a longer-term backdrop of aggregated feedback results.

The displayed results may show individual thread excerpts in text format but will not ascribe the thread to any of the multitude of microphones. In that way, anonymity is preserved.

One problem with ML is if the labeled data is inadvertently biased, the processing of new inputs may also be biased. The engineered ML subsystem, using current methods for reducing bias, will be trained for specific business establishment categories. As new labeled data is added, and human-agent oversight identifies errors, the ML models weighting will be adjusted to push toward optimized accuracy and minimized bias.

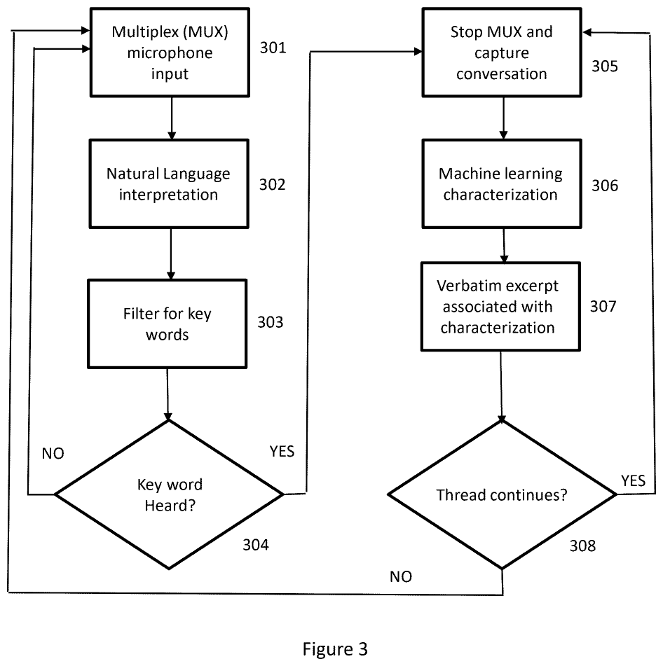

As illustrated in FIG. 3, one method embodiment comprises the depicted set of steps. Microphone input is multiplexed sequentially (301) and NL interpreted (302). Next, the interpreted thread is filtered for predetermined key words (303). If none are identified, the multiplexor will continue to sequentially select microphone inputs (304) or, if a key word is identified, the system will halt the multiplexor (305) to allow more of the thread to be translated and interpreted. The interpreted output is then processed by the ML module looking for categorization and perception (306). A verbatim text excerpt may be associated with the ML processed thread categorization (307). This will continue as long as the thread continues (308). Once the thread concludes, the system returns to multiplexing microphone inputs (301).

As noted, the restaurant example is just one example. One could envision a similar embodiment being used anywhere customer conversation would be ongoing, such as a retail store, supermarket, big-box store, public areas, and the like.

The system structures and functions are known in the industry. For example, neural network architecture could be used for NL and ML subsystems. The number of microphones is related to the size of a business establishment. For higher speed, multiple systems could be working in parallel so that at any time two or more microphones are sampling customer commentary.

What is claimed is:

1. An anonymous, real-time, customer-feedback system comprising:
a plurality of microphones;
a multiplexor with analog-to-digital converter subsystem;
a natural-language-model module subsystem;
a machine-learning-module subsystem; and
a processing subsystem comprising:
a central processing unit;
non-volatile program memory;
read/write data memory; and
mass storage.

2. A claim as in claim 1 wherein the multiplexor is operative to sequentially switch microphone inputs, at predetermined times, in a predetermined order.

3. A claim as in claim 1 wherein the multiplexor is operative to sequentially switch microphone inputs, at predetermined times, in a random order.

4. A claim as in claim 1 wherein the microphone output is an analog voice signal.

5. A claim as in claim 1 wherein the analog voice signal is converted to a digital equivalent signal by the analog-to-digital convertor.

6. A claim as in claim 1 wherein the natural-language model module is operative to receive the digital equivalent signal and translate and interpret it based on predefined, business-specific, words and phrases.

7. A claim as in claim 1 wherein the machine-learning module is operative to receive the translated and interpreted output from the natural-language model module and to categorize it and ascribe to an output a positive or negative perception.

8. A method comprising:
a. multiplexing outputs of a plurality of microphones such that an output from only a single microphone is active at a time;
b. converting each active output from an analog voice signal to an equivalent digital signal;
c. converting the equivalent digital signal to equivalent text;
d. filtering by a natural-language model module the equivalent text for any predetermined key word;
if no key word found, continuing steps a through d; or
if a key word is found, halting further multiplexing; and
e. capturing conversation thread;
f. categorizing of the conversation thread by a machine-language module;
g. associating a verbatim conversation thread excerpt with its categorization result;
h. determining if the thread is continuing;
if thread continues, then continuing steps e though h;
if thread ends, then resuming steps a through d.
